(19) United States
(12) Patent Application Publication
(10) Pub. No.: US 2014/0032299 A1
(43) Pub. Date: Jan. 30, 2014

(54) VIRTUAL INTEGRATION OF A LOYALTY CARD WITH A POINT OF SALE SYSTEM

(71) Applicant: Five Stars Loyalty, Inc., Mountain View, CA (US)

(72) Inventors: Matthew Doka, San Francisco, CA (US); Victor Ho, San Francisco, CA (US); Kilian Koepsell, San Francisco, CA (US); Ram Mehta, San Francisco, CA (US)

(73) Assignee: Five Stars Loyalty, Inc., Mountain View, CA (US)

(21) Appl. No.: 14/044,228

(22) Filed: Oct. 2, 2013

Related U.S. Application Data
(63) Continuation of application No. 13/750,479, filed on Jan. 25, 2013.
(60) Provisional application No. 61/591,123, filed on Jan. 26, 2012.

(51) Int. Cl. G06Q 30/02

(52) U.S. Cl. CPC G06Q 30/0226; G06Q 30/0238
USPC 705/14.27

(57) ABSTRACT

Methods and supporting systems for administering a loyalty card program include an application residing on a plurality of heterogeneous point-of-sale devices that captures consumer transaction data, wherein the consumer transaction data include the identification of a loyalty card, While the loyalty card is uniquely attributed to an individual consumer, the card may be used to conduct transactions unrelated retail entities, each having its own respective loyalty program, such that values for the individual loyalty programs may be maintained.

### CROSS-REFERENCE TO RELATED APPLICATIONS

This application is a continuation of U.S. patent application Ser. No. 13/750,479, filed Jan. 25, 2013, which claims the benefit of U.S. Provisional Patent Application Ser. No. 61/591,123, filed on Jan. 26, 2012. The contents of all the above-listed patent applications are hereby incorporated by reference in their entirety.

### BACKGROUND

Over the last few decades, retail establishments have recognized the value in strong customer loyalty. One method of establishing and strengthening customer loyalty is a loyalty “program” where consumers enroll in the program and their purchases and use of services is tracked and rewarded. In some instances, loyalty programs use “cards” to identify the consumer. The cards are presented at a retail establishment and associated with the transaction.

Traditional loyalty cards and rewards programs, however, have several operational problems and limited scalability. Generally, each business, merchant, restaurant, store, etc. has its own loyalty card that it provides to its customers. While this may be convenient for the establishment, customers may get exhausted or bothered by carrying multiple rewards cards in their wallet or purse. They may forget to carry the specific loyalty/rewards card that they may require on any given day (e.g., a gas card to pump gas, a loyalty card at an ice cream shop for frequent purchasers, a discount card for a grocery store etc.). Because keeping track of multiple rewards cards is not practical for the consumer, retailers have a difficult time convincing consumers to join their programs, losing out on potential repeat customers and detailed knowledge about purchase habits.

In parallel, retailers are increasing the use of social network applications and the use of email communication to bolster their loyalty programs and promotions. As a result of this trend, customers have to manage an ever-increasing set of communication preferences and privacy settings across multiple stores and accounts. This creates a negative customer experience and reduces program participation.

Separately, point-of-sale systems (referred to herein “POS”) are used by merchants, businesses, retailers, etc. to conduct transactions with customers at the point of sale of a product. Typically, most loyalty and/or rewards card programs integrate directly into the POS software by allowing a clerk to enter or scan a loyalty card during a purchase. However, implementing a turn-key solution, especially for small businesses, is time consuming and difficult because of the number of loyalty/rewards cards systems and multiple types of POS software. To complicate matters even further, each POS may have a specific application programming interface (API) associated with it. Therefore, integrating a loyalty/rewards card program with each POS system in multiple locations can be time consuming, impractical and problematic.

Manually integrating a loyalty/rewards card program into each and every POS creates operational problems because physically integrating a loyalty/rewards card program into each POS system individually is consuming and impractical. Each store, business, retailer, etc. may have a different company that provides the POS system. Modifying the POS system to integrate a loyalty/rewards card program can be very expensive, leading to expensive licensing costs.

What is needed, therefore, is an improved method and supporting systems for integrating loyalty cards into POS systems.

### SUMMARY OF THE INVENTION

In various embodiments, the invention provides methods and supporting systems for implementing and administering a consumer loyalty card program that utilizes a single loyalty card to accrue and redeem program points, rewards and monetary values across multiple retail establishments. By using a client-based application that resides on various heterogeneous point-of-sale devices and captures transaction data from scanners, receipts, and print queues, the system can allocate loyalty points and awards to individual retail establishments, brands, and locations. The transaction data is associated with an individual consumer and her single loyalty card, but the rewards, points and other benefits are maintained at the specific establishment level.

Therefore, in a first aspect, a computer-implemented method for administering a loyalty card program includes receiving, over an electronic network, from multiple point-of-sale devices (some of which may operate using different operating systems and/or hardware), consumer transaction data. The consumer transaction data includes the identification of a loyalty card (either a physical card having a magnetic stripe, RFID, bar code, and/or a QR code, or a virtual electronic card stored on a mobile computing device) or a customer's unique identifier such as a phone number, account number, or both, which is uniquely attributed to an individual consumer. The card is used to conduct transactions at multiple unrelated retail entities, each having its own respective loyalty program. As such, the value of each transaction may be attributed to each establishment such that the consumer is credited for use of the loyalty card at each of the unrelated retail entities at which the consumer used the loyalty card and the loyalty card values for the consumer in each of the respective loyalty programs are maintained separately.

In some embodiments, the retail entities include one or more physical locations, and may also include one or more online e-commerce websites. In some cases, a client application is provided to each point-of-sale device to capture the consumer transaction data, which may be operating-system agnostic. The application may receive consumer transaction data from a scanner device in communication with the point-of-sale device, an electronic device using near-field communications techniques, and/or a print queue of the point-of-sale device. In certain cases, the client application appears as an independent window, separate from any software operating on the point-of-sale device, and does not interact with or directly communicate with the point-of-sale software via APIs or other means.

In some embodiments, the value attributed to each transaction is a monetary value, and the value may also be expressed as points, merchandise, and/or discounts. In some cases, offers may be sent to the consumer based on historical consumer transaction data. The offers may be for products and/or services from retail establishments already frequented by the consumer, or, in some cases, the offers may be for related products or services. The offers may also be based, at least in part, on geospatial data from a transaction, the retail establishment, the consumer, or some combination thereof. In some cases, information regarding the transaction may be broadcast or otherwise transmitted to members of the consumers' social network using one or more social network application platforms.

In another aspect, the invention provides a system for delivering an offer to a consumer. The system includes a processor for executing computer-executable instructions; and a memory for storing computer-executable instructions. When the instructions are executed by the processor, a loyalty card application is instantiated that implements the functionality of the methods described above. In one particular aspect, instantiations of the application collect consumer transaction data from multiple point-of-sale devices (many of which may use different operating systems, point-of-sale applications and/or hardware), which is then collected at a central server. The consumer transaction data includes the identification of a loyalty card (either a physical card having a magnetic stripe, bar code, and/or a QR code, or a virtual electronic card stored on a mobile computing device), which is uniquely attributed to an individual consumer. The loyalty card is used to conduct transactions at a plurality of unrelated retail entities, each having its own respective loyalty program. The application also attributes a value to each transaction such that each consumer is credited for use of the loyalty card at each of the unrelated retail entities at which the consumer used the loyalty card, and maintains separate loyalty card values for the consumer in each of the respective loyalty programs.

The system may also include a downloadable client application for installation on the plurality of point-of-sale devices that captures the consumer transaction. In certain cases, the client application appears as an independent window, separate from any software operating on the point-of-sale device, and does not interact with or directly communicate with the point-of-sale software via APIs or other means. The transaction data may be captured using a scanner device in communication with the point-of-sale device, a near-field communications protocol, and or character recognition techniques as applied against a paper or electronic receipt. In some instances, the client application also includes a geospatial location module for identifying a location of the consumer, the retail establishment, and/or the transaction. The system may also include a data storage module that stores the consumer transaction data.

### BRIEF DESCRIPTION OF THE FIGURES

FIG. 1 illustrates a system and various additional components of a loyalty card system according to one or more embodiments of the invention.

FIG. 2 illustrates a module view of the loyalty card system according to one or more embodiments of the invention.

FIG. 3 illustrates a process for using a loyalty card according to one or more embodiments.

FIG. 4 illustrates a process for using integrating a social graph view with the use of a loyalty card program according to one or more embodiments of the invention.

FIG. 5 illustrates a schematic of a system for implementing a loyalty card application according to one embodiment of the invention.

Other features of the present embodiments will be apparent from the accompanying drawings and from the disclosure of the various embodiments.

### DESCRIPTION OF THE INVENTION

Disclosed are methods and supporting systems that facilitate the virtual integration of multiple rewards card programs with point-of-sale (“POS”) systems. In one exemplary embodiment, the system includes centralized data storage and an application server, a distributed application that resides on each POS device, and, in some implementations, a consumer application for use on a mobile computing device and/or a conventional computer.

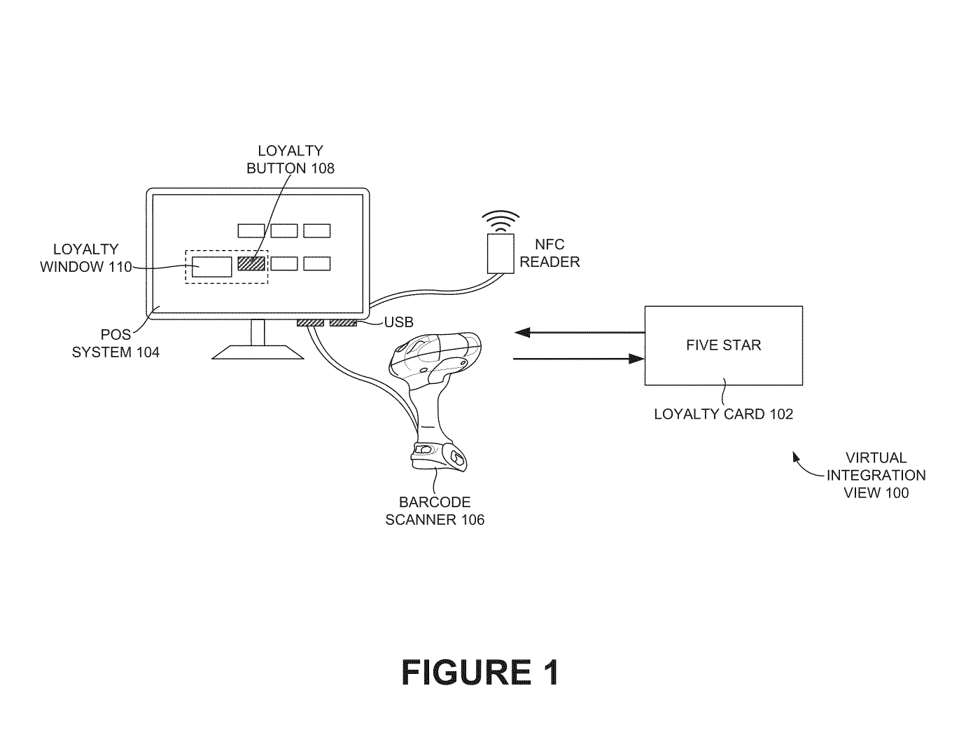

FIG. 1 illustrates one embodiment of a loyalty card system 100 for implementing the methods described below. The system facilitates the reading and identification of a loyalty card 102 that is held by, carried by and/or associated with a consumer that is enrolled in one or more loyalty card/brand programs offered by retailers, service providers, and brands. The system operates in conjunction with a POS system used to capture and execute retail transactions either at a physical location (e.g., a cash register or credit card reader) or online, using web-based shopping card and checkout functionality built into conventional e-commerce websites. In some instances, the card 102 is read using a barcode scanner 106. The scanner 106 may recognize optical codes (e.g. barcodes, QR codes, etc.), magnetically stored data (e.g., from the back of a credit card or debit card) or electronically stored data on card-embedded chips. The scanner 106 provides data regarding the consumer to the POS system 104.

In certain embodiments, the system includes an application that is downloaded to and operates on the POS system 104. The application may, when executed, initiate application windows on the POS system screen, such as a loyalty button 108 and or a loyalty window 110. In some cases, an NFC reader may be used to interact with electronic devices that utilize NFC protocols to transmit data, such as a loyalty card unique identifier or other consumer information.

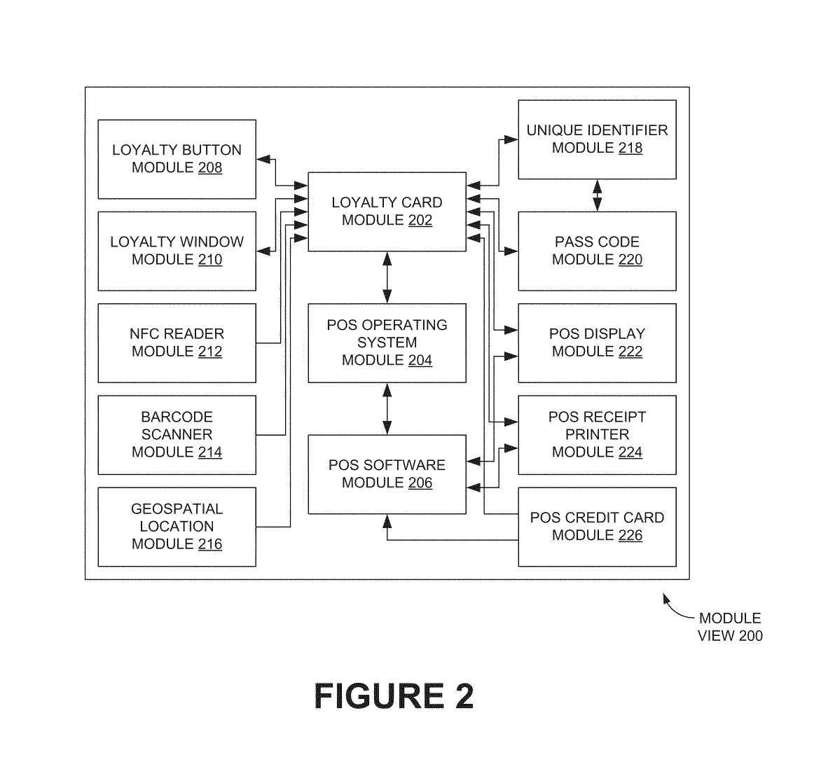

Referring to FIG. 2, the functions described herein may be implemented as stored software instructions organized into functional modules that perform specific tasks related to implementing and administering the loyalty card program. For example, the application may include a loyalty card module 202 for registering and identifying loyalty cards as they are presented to the POS system. The POS system may include its own operating system 204 (e.g., Windows, Linux, etc.) on which the POS software module 206 and the loyalty card application may operate. The loyalty card application may include a loyalty card button module 208 for presenting certain portions of the loyalty card application on the POS device when activated, as well as a loyalty window module 21 0 for displaying and receiving user identification data related to various different loyalty card programs. An NFC reader module supports the use of an NFC device to interact with electronic devices such as smartphones and other devices that utilize such technology to transmit data. A barcode scanner module 214 provide the software to operate and interact with the scanner device. In some cases, a geospatial location module 216 allows the application to receive location-based data from the consumer (typically from their mobile phone or computing device) and/or from the POS device itself

In practice, the loyalty program tracking and administration system supports the implementation and ongoing administration of a diverse variety of marketing programs that reward, and therefore encourage, loyal buying behavior. In marketing generally and in retailing more specifically, a loyalty card, rewards card, points card, advantage card, or club card may take the form of a plastic or paper card, visually similar to a credit card or debit card that may identify the card holder as a member in a loyalty program. Cards typically may have a barcode, magstripe or embedded chip that may be scanned or electronically read, or a number imprinted on the card that may be read by a clerk. According to another embodiment, a small key ring card (e.g., a keytag) which may serve as key fobs may often be used for convenience in carrying and ease of access. In some cases, the loyalty card may be “virtual” in only the number or code be shown or scanned while being presented electronically, (e.g., as an image on a smartphone, tablet or other similar device). In other cases, the actual card itself is not material to the transaction, and the consumer may simply recite a loyalty number, an account number, or a phone number.

Retail establishments typically issue loyalty/rewards cards to consumers, who then use their card as a form of identification when interacting with that retailer. By presenting the card, the purchaser may be entitled to either a discount on the current purchase, an allotment of points that may be used for future purchases, or offers for other discounts and products at that retailer or, in some cases, partner retailers. Typically consumers achieve certain point levels or purchase levels (e.g., one free cup of coffee for every ten cups of coffee purchased) and redeem the saved value for additional merchandise and/or services. By continuing to reward the consumer for their repeated purchases, the retailers have a better chance of retaining that customer over time and building brand loyalty. Loyalty programs may be predominantly run by retailers and the service industry, but recent advances in POS systems and supporting technology may increase participation by manufacturers of consumer products, according to one or more embodiments.

The card issuer may request or require customers to provide a usually minimal amount of identifying or demographic data, such as phone, email, name and birthday in order to receive a loyalty card. In some cases, this data may be used to tailor specific offers to the consumer. In many instances, the application process also entails agreeing to certain terms of use and reviewing privacy provisions, which is most often directed to safeguarding non-aggregated data about the consumers. In some cases, the retail establishment issuing the cards and administering the loyalty/rewards card program may use the aggregate data internally or externally as part of its marketing research.

Once a consumer has provided sufficient identifying information, the loyalty/rewards card may also be used to expedite identification and/or verification during receipt of checks or dispensing of medical prescription preparations, or for other membership privileges (e.g., access to a club lounge in airports or using a frequent flyer card). For example, the card may be swiped and confirm the identity, account number or other credential of the consumer.

Referring now to FIG. 2, one aspect of the invention provides a downloadable and installable application that can operate on top of or in conjunction with an operational POS system, regardless of the software and hardware platform on with the POS operates. The application communicates with the central server to collect, aggregate and analyze the POS and loyalty program data across multiple programs, retailers and platforms. Conventional rewards programs integrate directly into the POS system's proprietary software, meaning each implementation requires integration through a distinct API for its proprietary software. As a result, systems that implement and support traditional loyalty/rewards programs must be written for specific POS devices or platforms, and cannot provide a global view of consumer purchase data across multiple loyalty programs from different retailers and/or brands.

According to various embodiments, a download installer may be used to virtually integrate the loyalty card application into the POS system. The download installer may operate as a “click-through” installation process that does not require any special computer or system knowledge. As such, the installation process enables the loyalty card application to be installed onto the same device operating the POS system.

Rather than rely on and require specific programming for each of the different APIs of the various POS vendors, merchants or retailers, embodiments of the invention provide for a separate application that may be downloaded onto each POS machine/system. By operating independently from the POS system, the application facilitates the virtual integration of a loyalty card/program on a large number of POS systems with far less programming or integration effort than conventional approaches that require specific integration to multiple POS systems. In certain implementations, the loyalty/rewards card program is implemented as a “button” or icon that may be installed in, within, or on top of a POS system's software. By selecting the icon or button, a clerk, salesperson, waiter or other retail worker can initiate the loyalty/rewards program for each transaction. The button may be used to redeem discounts, rewards, etc., depending on the parameters of the loyalty program implemented at the specific retailer.

In practice, when a consumer approaches a checkout or other POS device, a barcode scanner or NFC reader may be employed to scan the loyalty card or the virtual loyalty card stored in the mobile application. The scanner may be used by a clerk, or in some cases may be implemented as part of a self-checkout kiosk or station. Once a loyalty card is presented and recognized, a window appears on the screen and appears as if the loyalty card was part of and integrated into the POS system's proprietary software. The retail clerk and/or consumer may then interact with the POS system to initiate the desired loyalty card transaction. In some instances, a screen may appear that allows the clerk to enter certain consumer information, such as a partial name, phone number, email or other ID in order to look up additional loyalty card information such as recent transactions, available discounts, and account data.

The transactions may include adding loyalty points to their account, redeeming points for discounts and/or free merchandise or services, or updating personal information associated with their account. For example, when a consumer presents their loyalty card a screen may appear within the application that allows the clerk to add and/or redeem loyalty points to the consumer's account that are specific to the retail establishment, or points that are “generic” to the loyalty program generally. Once the loyalty card transaction is completed, the consumer or clerk may tap or otherwise indicate to the application that the transaction is complete and the window is closed.

For example, to implement a loyalty card program at all Starbucks™ locations, a considerable amount of time and money would be necessary to integrate the loyalty card application software into the API for the MICROS™ POS terminals. Then, Starbucks™ would need to individually install a program at each Starbucks™ location. This form of integration requires customization and installation skills to configure each of the POS devices to ensure that the model is used correctly and without error.

In contrast, using the loyalty card application described herein, a request may be made from Starbucks'™ corporate offices to implement a loyalty card program and the loyalty card application may then be efficiently installed on each POS system at all Starbucks™ locations. In some cases, information may be gathered (e.g., the model numbers of all POS systems at different Starbucks™ locations) and used to get updates on the various POS systems in use and the software installed on each device.

In some embodiments, the loyalty card application may utilize color schemes, logos, icons, text and or “skins” provided by the retailer that are automatically used to modify the look and feel of the application as to appear that it is fully integrated with the retail POS system. For example, the application may include screen areas, background wallpaper, font settings and other parameters that are easily customized for particular brands without needing custom programming. The retailer may provide a set of files (e.g., JPEG files, GIF files, font styles, color settings, etc.) that are read by the application at run-time and integrated into the application as it executes. As a specific example, a POS system at a coffee shop may have buttons on its screen for the various products sold, such as “coffee” and “tea.” The loyalty application button may be positioned on top of the screen of the POS system so that it is easily accessible and appears to the clerk as part of the POS process.

In some instances, the loyalty card application may be automatically launched in response to a POS transaction. For example, the loyalty card software can monitor the print queue of the native operating system on the POS device to identify the printing of a receipt. As an example, on a WINDOWS-based device, the application may periodically (e.g., every second) poll the Win32Print API to detect the printing of a receipt. This allows the loyalty card program to recognize each and every time a transaction occurs on the POS without integrating into the POS software. In other examples, the application may respond to other device operations such as the use of a scanner, the request for a credit card authorization, or other events that may be monitored through the operating system messaging queues. The response of the loyalty card software to receipt printing events may be seamless so as to look and feel the same way as the POS system's proprietary software.

In addition to facilitating loyalty card transactions at the POS, the loyalty card application can also collect transaction data—again without needing to be directly integrated into the POS software. For example, the application may monitor the screen display message queue to capture and read a text version of the screen contents at the time of receipt printing. In some cases, the application may also pass or redirect all receipt print requests to a software printer. Alternatively, hardware or software port interception may be used to intercept and decode receipt printer output. Once captured, the receipt data may be sent to the central server and stored as transactional data for that consumer, thus automatically capturing her specific purchases and the amount(s) paid for each item. In other examples, a screen shot of the POS device may be captured and analyzed on the server using conventional character recognition algorithms.

In other examples, the loyalty card application may access credit card transactions on the POS terminal without integrating into the POS software by monitoring the messaging queue or integrating into the API of the credit card hardware. The loyalty card application may use the credit card hardware device to capture and process credit cards as payment for products offered through the loyalty card software (e.g., gift cards, promotional items, etc.). In each case, however, the payment experience for the customer and merchant will appear seamless as a result of the integration.

In some implementations, the loyalty card program may use a generic barcode scanner that may be provided to the retail establishment as part of the loyalty card program. The barcode scanner may be plugged into the POS system's universal serial bus (USB) port and configured to operate as a conventional scanner device. In other versions, a near-field communications (NFC) scanner may be used to capture the card number and used to store rewards, points, benefits, discounts, etc.

In some cases, the application may utilize a passcode function when capturing POS data for individual transactions when a user scans the loyalty card with the USB barcode scanner. The passcode may be a hashed version of an alphanumeric code such as the barcode read off of a purchased product or the card itself The code may then be used to identify a transaction and/or a consumer based on data entered or scanned by the user.

According to various implementations, consumers may use a single loyalty card at multiple different locations, retail establishments, businesses, restaurants, etc. in order to eliminate the need to carry and track multiple cards from the various establishments they frequent. According to these embodiments, the consumer may carry one loyalty card having a unique identifier associated with that particular consumer. The points and rewards may be captured using the same application and card, but stored at the central server in a manner that maintains the distinction between the different loyalty programs at each establishment. For example, the consumer may present her “universal” loyalty card when shopping at her local pharmacy, her neighborhood grocery store, her cleaners, and the local coffee house. In each case, the loyalty card application, having been downloaded and installed onto the POS devices at each location, captures her transactions at the four stores using a common application and card.

For example, the central server may have stored thereon data records that associate the unique loyalty card used by the consumer with the various store or brand-specific programs. As such, the individual transactions can be captured using the single loyalty card and common application, but individual balances for each retail program are maintained. Moreover, for brand-specific programs (e.g., where a consumer may get points or rewards for purchasing a particular brand, as opposed to or in addition to shopping at a specific store) the receipt-level detail information may be used to allocate points to the proper brands. By capturing data across multiple establishments and transactions, the system can identify purchasing trends across different merchants, brands, regions, and other parameters. Moreover, while the points and rewards earned for each of a consumer's individual loyalty programs remain separate, data about the consumer themselves can be shared among the participating brands. For example, when a consumer travels to a new city and presents her card at a Marriott hotel during check in, the local Starbucks may then be notified that she is nearby and a text message may be sent to the consumer offering a free beverage.

In certain implementations, the loyalty card may also operate as a stored value or gift card on which the consumer can store and accrue value for redemption at one or more retailers. For example, a consumer may load $50 onto his loyalty card for use with the Starbucks card program, and an additional $100 on the same card for use at Pizza Hut. The application maintains the distinction between the two programs, even though the same card is used to store and redeem the benefits. As such, the consumer need only use one card to get the benefits of his purchases across multiple brands and locations.

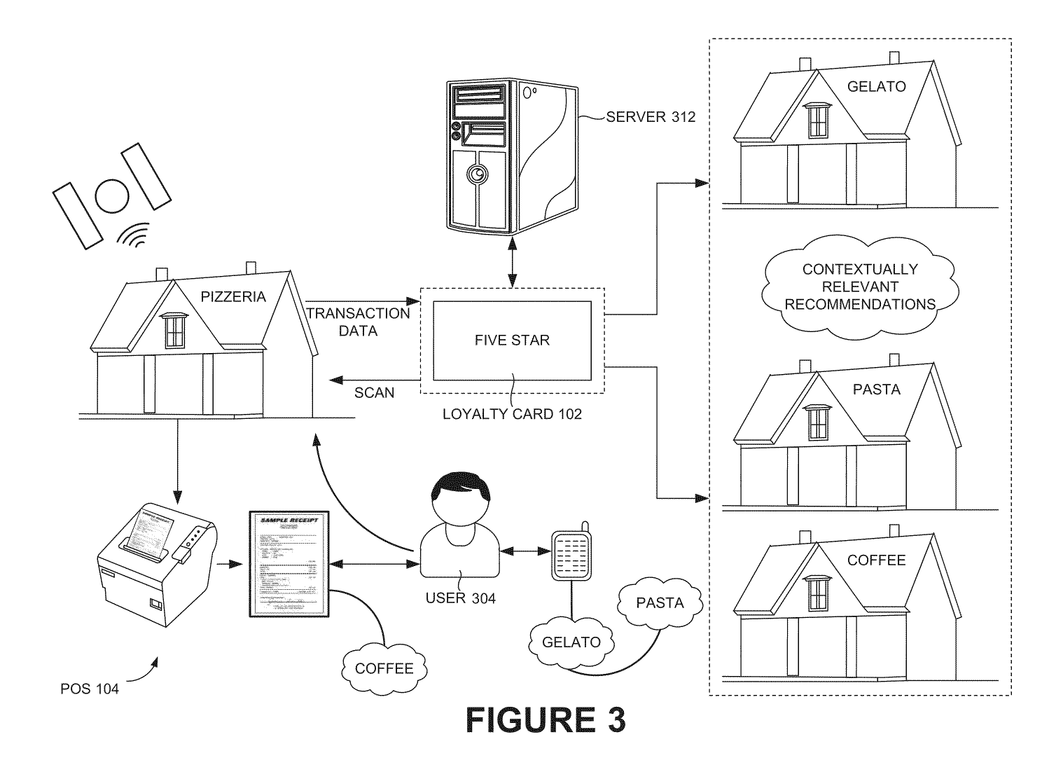

The loyalty card application may also provide advertisements to consumers based on usage and contextually related entities. Referring to FIG. 3, a consumer 304 uses his loyalty card 102 at a local pizzeria to purchase dinner. The POS system 104 at the pizzeria identifies the consumer based on his card and scans the receipt. The receipt is scanned and individual items are identified from the purchase (e.g., a coffee purchase) and the transaction data is sent to the loyalty card application server 312. The server 312 determines one or more advertisements that are related to the purchase, such as discounts for a subsequent visit to the pizzeria, discount coupons for coffee, gelato, or pasta.

The loyalty card application may also work in tandem with a consumer-based application (an “app”) that may be downloaded and installed on a smart phone, tablet, or other personal communication device. Having the app on the consumers' devices allows the retailers and/or the entity that administers the loyalty card application to implement various other marketing programs. For example, if the consumer has the app executing on their device and has allowed the app access to location-based data, the system may send the consumer an in app message, text message, email message, or direct the consumer to a web page of a local establishment that is offering a deal based on their enrollment in and ongoing use of the loyalty program.

More specifically, the system may generate and send geospatially targeted recommendations that are contextually relevant to the consumers present location or a location at which their loyalty card was recently scanned. The recommendations may advertise another retail establishment, offering a discount to a complementary product (relevant to a recently purchased product), or any other form that would drive advertising based on a user's preferences and past purchases.

In some instances, the data generated by use of the loyalty card may be shared with other users of the application and/or members of the consumer's social graph. In this instance, a user's social graph includes any other individuals or entities that are in any way “connected” to the consumer using one or more social networking applications (e.g., Facebook, Google+, Linkedln, Twitter, and FourSquare, etc.) or messaging applications (chat or email). For example, when a consumer achieves a certain level according to one loyalty program, a status message may be generated that is shared with the consumer's connections, thus broadcasting their newly achieved status. In other cases, the consumer may be awarded additional points or discounts by allowing the system to share her achievements or purchases with their friends. According to yet another exemplary embodiment, the consumer's social graph may be analyzed to identify opportunities for merchants to advertise to other members of the social graph that have similar purchase histories, are located in the same area, are traveling to the same region, and/or who have opted into receiving such notices.

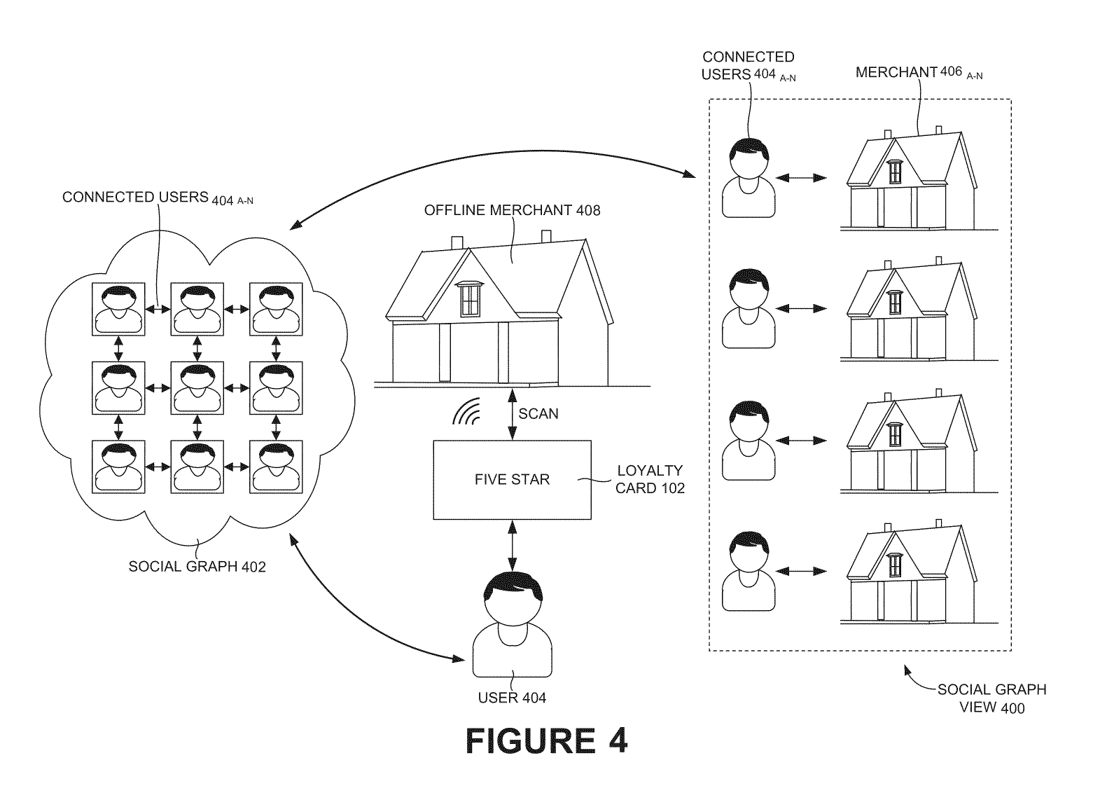

For example, FIG. 4 illustrates how a consumer 404 may use her loyalty card 102 at a specific merchant 408 to complete a transaction. Based on that transaction, the loyalty card application reviews that user's social graph 402, or creates a status event for a social network platform and posts the event to each of the consumers connected users 404. Based on those messages and events, the connected users may then visit the same or additional merchants 406.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

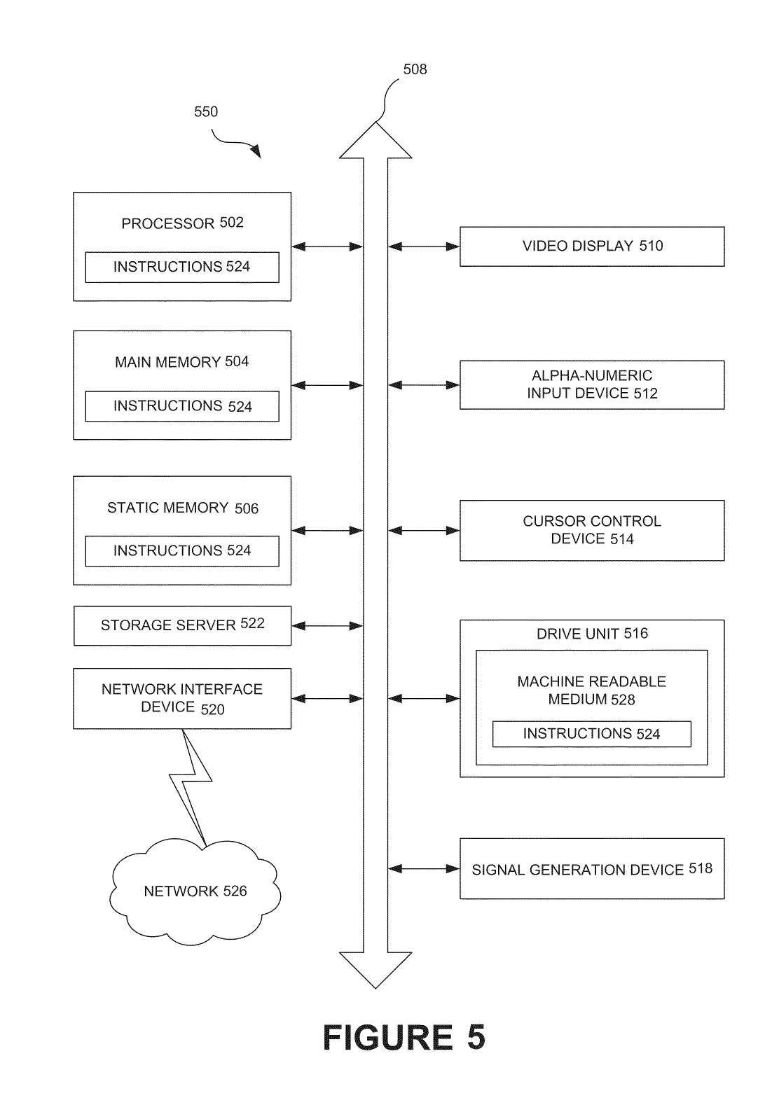

Referring to FIG. 5, all modules of FIG. 2 may be enabled using software and/or using transistors, logic gates, and electrical circuits (e.g., application specific integrated ASIC circuitry) such as a security circuit, a recognition circuit, a tactile pattern circuit, an association circuit, a store circuit, a transform circuit, an initial state circuit, an unlock circuit, a deny circuit, a determination circuit, a permit circuit, a user circuit, a region circuit, and other circuits.

FIG. 5 may indicate a personal computer and/or the data processing system in which one or more operations disclosed herein may be performed. The processor 502 may be a microprocessor, a state machine, an application specific integrated circuit, a field programmable gate array, etc. (e.g., Intel® Pentium® processor, 620 MHz ARM 1176, etc.). The main memory 504 may be a dynamic random access memory, a non-transitory memory, and/or a primary memory of a computer system.

The static memory 506 may be a hard drive, a flash drive, and/or other memory information associated with the data processing system. The bus 508 may be an interconnection between various circuits and/or structures of the data processing system. The video display 510 may provide graphical representation of information on the data processing system. The alphanumeric input device 512 may be a keypad, a keyboard, a virtual keypad of a touchscreen and/or any other input device of text.

The cursor control device 514 may be a pointing device such as a mouse. The drive unit 516 may be the hard drive, a storage system, and/or other longer term storage subsystem. The signal generation device 518 may be a bios and/or a functional operating system of the data processing system. The network interface device 520 may be a device that performs interface functions such as code conversion, protocol conversion and/or buffering required for communication to and from the network 526. The machine readable medium 528 may provide instructions on which any of the methods disclosed herein may be performed. The instructions 524 may provide source code and/or data code to the processor 502 to enable any one or more operations disclosed herein.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations).

The methods and systems disclosed herein may be implemented in any means for achieving various aspects, and may be executed in a form of a machine-readable medium embodying a set of instructions that, when executed by a machine, cause the machine to perform any of the operations disclosed herein. Accordingly, the specification and the drawings are regarded in an illustrative rather than a restrictive sense.

What is claimed is:

1. A computer-implemented method for administering a loyalty card program, the method comprising the steps of:
receiving over an electronic network, from a plurality of point-of-sale devices, consumer transaction data, wherein the consumer transaction data comprises an identification of a loyalty card, the loyalty card being uniquely attributed to an individual consumer and wherein the single loyalty card is used to conduct transactions at a plurality of unrelated retail entities, each having its own respective loyalty program;
attributing a value to each transaction such that each consumer is credited for use of the loyalty card at each of the unrelated retail entities at which the consumer used the loyalty card; and
maintaining separate loyalty card values for the consumer in each of the respective loyalty programs.

2. The method of claim 1 wherein the retail entities comprise one or more physical locations.

3. The method of claim 1 wherein the retail entities comprise one or more online e-commerce websites.

4. The method of claim 1 wherein the plurality of point-of-sale devices operate using a plurality of different operating systems.

5. The method of claim 4 further comprising providing a client application to each point-of-sale device to capture the consumer transaction data.

6. The method of claim 5 wherein the client application is operating-system agnostic.

7. The method of claim 5 wherein the client application presents as an independent window screen separately from software operating on the point-of-sale device.

8. The method of claim 5 wherein the client application receives consumer transaction data from a scanner device in communication with the point-of-sale device.

9. The method of claim 5 wherein the application received consumer transaction data from a print messaging system of the point-of-sale device.

10. The method of claim 1 wherein the value attributed to each transaction is a monetary value.

11. The method of claim 1 further comprising transmitting an electronic offer to the consumer based on the consumer transaction data.

12. The method of claim 1 further comprising receiving geospatial location data regarding the location of one or more of the consumer and the retail establishment at which a transaction is being completed.

13. The method of claim 1 further comprising receiving social network data for the consumer and transmitting information about the transactions to members of the consumers social network.

14. The method of claim 1 wherein the loyalty card comprises a virtual loyalty card stored electronically on a mobile communications device.

15. The method of claim 14 wherein data from the loyalty card is transmitted to the point-of-sale device using a near-field communications protocol.

16. A system for administering a loyalty card program, the system comprising:
a processor for executing computer-executable instructions; and
a memory for storing computer-executable instructions, that when executed by the processor implements a loyalty card application, wherein the loyalty card application (a) receives, from a plurality of point-of-sale devices, consumer transaction data, wherein the consumer transaction data comprises an identification of a loyalty card, the loyalty card being uniquely attributed to an individual consumer and wherein the single loyalty card is used to conduct transactions at a plurality of unrelated retail entities, each having its own respective loyalty program, (b) attributes a value to each transaction such that each consumer is credited for use of the loyalty card at each of the unrelated retail entities at which the consumer used the loyalty card, and (c) maintains separate loyalty card values for the consumer in each of the respective loyalty programs.

17. The system of claim 16 further comprising a downloadable client application for installation on the plurality of point-of-sale devices, and wherein the client application captures the consumer transaction data.

18. The system of claim 17 wherein the client application is operating system agnostic.

19. The system of claim 17 wherein the client application presents as an independent window screen separately from software operating on the point-of-sale device.

20. The system of claim 17 wherein the client application comprises a barcode scanner module for receiving consumer transaction data from a scanner device in communication with the point-of-sale device.

21. The system of claim 17 wherein the client application comprises a geospatial location module for identifying a location of one or more of the consumer and the transaction.

22. The system of claim 17 wherein the client application comprises a near-field communications module for wirelessly receiving loyalty card data from a mobile communications device.

23. The system of claim 16 further comprising a data storage module that stores the consumer transaction data.
